(19) United States
(12) Patent Application Publication
(10) Pub. No.: US 2024/0418403 A1
(43) Pub. Date: Dec. 19, 2024

(54) FLUID HEATER

(71) Applicants: Hanon Systems, Daejeon (KR); DAEWOO ELECTRONIC COMPONENTS CO., LTD., Jeonbuk-do (KR)

(72) Inventors: Yong Ha Chae, Daejeon (KR); Young Gun Kim, Jeonbuk-Do (KR); Man Ok Lee, Gwangju (KR); Hyung Yeol Yoon, Jeonbuk-Do (KR); Jongoh Park, Jeonbuk-Do (KR); Kil Sang Jang, Daejeon (KR)

(21) Appl. No.: 18/696,678

(22) PCT Filed: Nov. 15, 2022
(86) PCT No.: PCT/KR2022/018002

§ 371 Date: Mar. 28, 2024

(30) Foreign Application Priority Data
Nov. 15, 2021 (KR) 10-2021-0156529

(51) Int. Cl. F24H 1/00; F24H 15/128

(52) U.S. Cl. CPC F24H 1/009; F24H 15/128

(57) ABSTRACT

The present invention relates to a fluid heater including a casing having therein a hollow portion in which a fluid flows, a heating module including a connector disposed outside the casing and connected to a power source, and a heating element disposed in the casing and configured to be heated by electric power transmitted from the connector, and a heat transfer module configured to transfer heat, which is generated by the heating element, to one surface of the casing, in which the heat transfer module is in contact with an inner surface of a plate having one end being in contact with the heating element, and the other end disposed on one surface of the casing, such that heat generated by the heating element is transferred directly to the plate, thereby enabling more precise measurement and preventing an accident.

### TECHNICAL FIELD

The present invention relates to a fluid heater, and more particularly, to a fluid heater mounted in a vehicle and configured to heat a fluid, such as a coolant, by means of a heating element.

### BACKGROUND ART

In the related art, fossil fuel vehicles equipped with engines, which use fossil fuel such as gasoline or light oil as energy sources, have been widely used. However, in the related art, the use of fossil fuel as an energy source causes social problems of environmental pollution and also causes problems of resource depletion. Therefore, in order to solve the above-mentioned problems, environmental-friendly vehicles equipped with fuel cells, batteries, or the like have been developed and are currently, practically, and widely used.

However, there is a problem in that a heating system, which has been designed and developed over a long period of time and used for a fossil fuel vehicle in the related art, is difficult to use for the environmental-friendly vehicle equipped with the fuel cell, the battery, or the like. Because the engine of the fossil fuel vehicle in the related art generates mechanical energy by using thermal energy generated by combusting fossil fuel, a fluid may be heated by a part of the thermal energy generated by the combustion. As the fluid, which is heated by the thermal energy generated by the engine, circulates, the fluid may be used to heat a vehicle interior. In contrast, because the fuel cell or the battery generates heat smaller in amount than the heat generated by the engine, there is a limitation in applying the heating system having the above-mentioned heating function. In order to establish an independent heating system, the environmental-friendly vehicle equipped with the fuel cell or the battery has been developed and utilized in such a manner that a heat pump may be added and used as a heat source or a separate heat source such as an electric heater may be provided. Among the heat sources, the electric heater is more widely used because the electric heater may easily heat the fluid without greatly affecting other air conditioning systems. In this case, the electric heaters may be classified into an air heating heater configured to directly heat air to be blown to the vehicle interior, and a coolant heating heater configured to heat a coolant.

In the case of the electric heater, when power is continuously applied to a heater part even in a situation in which the supply of the power applied to the heater part needs to be cut off in an abnormal state such as the absence of the coolant, a breakdown of a temperature sensor, a breakdown of a controller, and other vehicle breakdowns, a temperature is continuously increased, which may cause a risk that the device is broken down or a fire occurs. Therefore, Korean Patent No. 10-1655813 (published on Sep. 2, 2016, and entitled “Device for Preventing Battery Heater from Being Overheated”, hereinafter, referred to as the ‘patent document’) discloses a configuration for preventing a coolant heater from being overheated. With reference to FIG. 1, the patent document includes a heater part 2 configured to heat a heat exchange fluid, a temperature sensitive switch 3 configured to cut off a supply of power applied to the heater part 2, and a heat transfer member 4 configured to transfer heat of the heater part 2 to the temperature sensitive switch 3. In this case, the heat transfer member 4 has a plate structure and is configured such that one surface thereof is in contact with the heater part 2 or the heat exchange fluid, and the other surface thereof is in contact with the temperature sensitive switch 3.

The structure of the patent document is advantageous in that the structure may prevent overheating by transferring heat from the heater part or the heat exchange fluid. However, the structure of the patent document has several problems in that overheating detection responsiveness is not good, the mounting structure for the structure is complicated and unstable, manufacturing or assembling costs are increased, and it is difficult to ensure performance. Furthermore, because the heat transfer member made of a thermally conductive material is coupled to a heater, durability is lowered, which causes a problem in that the heat transfer member is deformed or a leak occurs because the heater is overheated during an abnormal operation. Further, because the heat transfer member receives heat from a member or the heat exchange fluid between a heat generating part and a connector without receiving heat from the heat generating part of the heater, it is difficult to perform the measurement when the fluid is not in contact with the heat transfer member, which causes a problem in that the function of preventing overheating of the heater is incomplete.

### DOCUMENTS OF RELATED ART

### Patent Documents

KR 10-1655813 B1 (published on Sep. 8, 2016)
JP 2011-016489 A (published on Jan. 27, 2011)

### DISCLOSURE

### Technical Problem

The present invention has been made in an effort to solve the above-mentioned problem, and an object of the present invention is to provide a fluid heater for a vehicle that is configured such that heat generated by a heating element may be transferred to a plate that constitutes a casing.

### Technical Solution

In order to achieve the above-mentioned object, a fluid heater according to the present invention includes: a casing having therein a hollow portion in which a fluid flows; a heating module including a connector disposed outside the casing and connected to a power source, and a heating element disposed in the casing and configured to be heated by electric power transmitted from the connector; and a heat transfer module configured to transfer heat, which is generated by the heating element, to one surface of the casing, in which the heat transfer module is in contact with an inner surface of a plate having one end being in contact with the heating element, and the other end disposed on one surface of the casing.

In addition, in the fluid heater of the present invention, a part of the plate may be recessed toward an interior of the casing to define a depressed portion, and the other end of the heat transfer module may be in contact with an inner surface of the depressed portion.

In addition, in the fluid heater of the present invention, at least one of a temperature fuse, a temperature sensitive switch, and a temperature sensor may be disposed on an outer surface of the depressed portion.

In addition, in the fluid heater of the present invention, the inner surface of the depressed portion may have an embossed shape.

In addition, the heat transfer module may include: a first transfer member being in contact with an outer surface of the heating element while surrounding the outer surface of the heating element; and a second transfer member having one end connected to the first transfer member and the other end coupled to the inner surface of the plate.

In addition, the heat transfer module may include: a first transfer member being in contact with an outer surface of the heating element while surrounding the outer surface of the heating element; and a second transfer member having one end connected to the first transfer member and the other end coupled to the inner surface of the depressed portion, and the second transfer member may include: a connection member having one end connected to the first transfer member; and a fixing member connected to the other end of the connection member and fixed to be in surface contact with the inner surface of the depressed portion.

In addition, the heating element may be formed spirally and include a plurality of unit heating elements inclined at a predetermined angle, and the first transfer member may be shaped to correspond to an outer peripheral surface of the adjacent unit heating element.

In addition, the connector may penetrate the plate, and the connector and the plate may be coupled by brazing.

In addition, in the fluid heater of the present invention, the connector may be provided as a plurality of connectors, and the two or more connectors may be disposed to penetrate one plate.

In addition, in the fluid heater of the present invention, at least one connector including a positive electrode terminal may be disposed to penetrate one plate.

In addition, the plate may have a hole into which the connector is inserted, and a protruding portion may be formed around the hole of the plate and protrude inward or outward from the casing.

In addition, in the fluid heater of the present invention, the other end of the heat transfer module and the inner surface of the plate may be coupled to each other by brazing.

In addition, the casing may further include: an inlet port 10a into which a coolant is introduced; and a discharge port 10b through which the coolant is discharged, and the discharge port may be disposed to be closer to the plate than the inlet port.

### Advantageous Effects

According to the fluid heater according to the present invention configured as described above, the heat of the main heating component is transferred directly to the plate from the heating element, such that the temperature fuse, the temperature sensitive switch, the temperature sensor, or the like may detect the normality or abnormality, thereby improving measurement precision and reliability and preventing an accident such as the occurrence of a fire.

Further, the fluid heater according to the present invention may minimize a gap between the heating element and the plate by means of the depressed portion coupled to the plate, thereby maximizing the temperature detection reactivity and preventing the deformation of the plate.

Further, according to the fluid heater according to the present invention, the heating module and the heat transfer module may be coupled to the plate by brazing, thereby improving the heat transfer rate, the durability, and the quality of the product.

### BRIEF DESCRIPTION OF THE DRAWINGS

FIG. 1 is a perspective view illustrating an overheating prevention device of a battery heater in the related art.

FIG. 2 is a perspective view illustrating a fluid heater according to an embodiment of the present invention in a state in which an interior of the fluid heater is projected.

FIG. 3 is a cross-sectional front view illustrating the fluid heater according to the embodiment of the present invention.

FIG. 4 is a perspective view illustrating the fluid heater according to the embodiment of the present invention in a state in which a part of a casing is removed.

FIG. 5 is a front view illustrating the fluid heater according to the embodiment of the present invention in a state in which a part of the casing is removed.

FIG. 6 is a side view illustrating the fluid heater according to the embodiment of the present invention in a state in which a part of the casing is removed.

FIG. 7 and FIG. 8 is a perspective view illustrating a plate according to the embodiment of the present invention.

FIG. 9 is a side view illustrating a fluid heater according to another embodiment of the present invention in a state in which a part of a casing is removed.

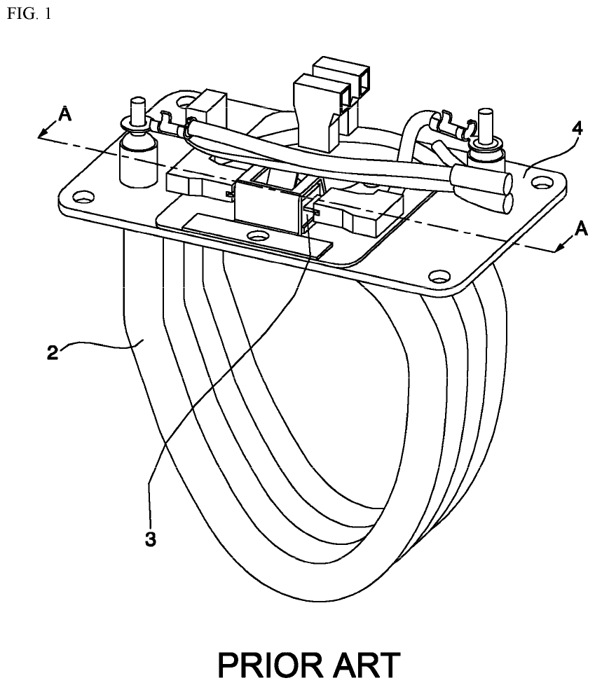

### MODE FOR INVENTION

Hereinafter, a fluid heater according to the present invention configured as described above will be described in detail with reference to the accompanying drawings.

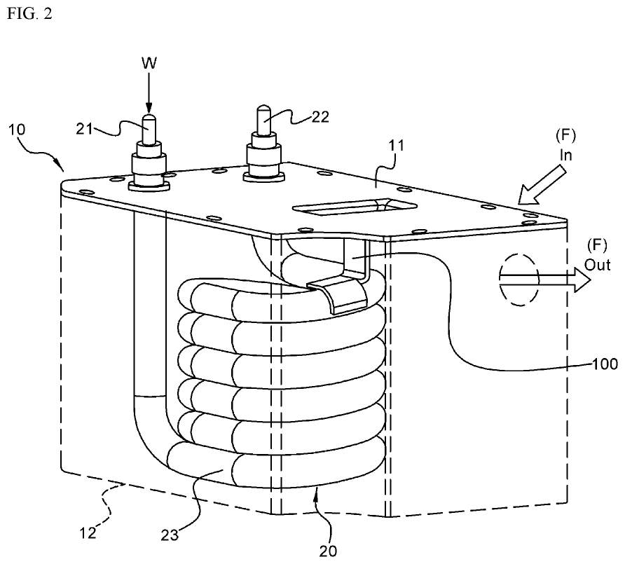

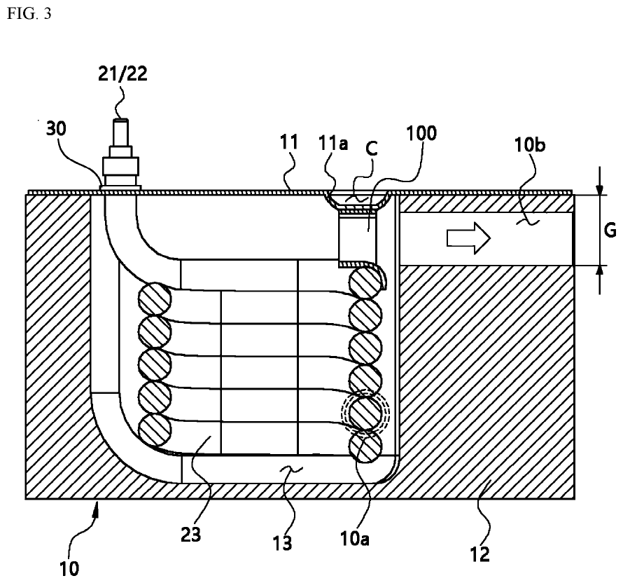

FIGS. 2 and 3 are related to a fluid heater according to an embodiment of the present invention. FIG. 2 is a perspective view illustrating the fluid heater in a state in which an interior of the fluid heater is projected, and FIG. 3 is a cross-sectional front view illustrating the fluid heater.

With reference to FIG. 2, the fluid heater according to the embodiment of the present invention may include a casing 10, a heating module 20, and a heat transfer module 100. In this case, the casing 10 may include a plate 11 disposed at one side, and a casing body 12 coupled to the plate 11 and configured to seal an interior of the casing 10. A fluid, such as a coolant F, may be introduced into or discharged from the casing body 12, such that the coolant F may flow in the casing 10.

The heating module 20 may include a pair of connectors 21 and 22, and a heating element 23 connected to the pair of connectors 21 and 22 and configured to generate heat by means of electric power. In this case, the pair of connectors 21 and 22 may be partially exposed to the outside of the casing 10. The heating element 23 may be connected to the pair of connectors 21 and 22, disposed in the casing 10, and configured to heat the flowing coolant F. In this case, the pair of connectors 21 and 22 may be modified in various shapes in which the pair of connectors 21 and 22 is disposed to penetrate the plate 11, any one of the pair of connectors 21 and 22 penetrates the plate 11, or the pair of connectors 21 and 22 penetrates the casing body 12. Further, the connectors may be provided as a pair of connectors or more connectors. Alternatively, the connector may be configured as a single connector embedded with a positive electrode terminal.

With reference to FIG. 3, one end of the heat transfer module 100 may be in contact with the heating element 23, and the other end of the heat transfer module 100 may be in contact with an inner surface of the plate 11. Further, the heat transfer module 100 may transfer heat, which is generated by the heating element 23, to the plate 11. In this case, although not illustrated, a means, such as a temperature fuse, a temperature sensitive switch, or a temperature sensor, capable of measuring a temperature or a means capable of controlling a supply of electric power while measuring a temperature may be disposed on the plate 11. The means may measure the temperature of the heating element 23 by measuring the temperature of the plate 11 by receiving heat through the plate 11.

A part of the plate 11 may be formed as a depressed portion 11a by being recessed toward a casing interior 13 in which the coolant flows. In this case, the depressed portion 11a has a shape recessed toward the casing interior 13, and a seating portion C is formed on an outer surface of the depressed portion 11a, such that the temperature fuse, the temperature sensitive switch, the temperature sensor, or the like may be disposed in the seating portion C. Further, the other end of the heat transfer module 100 may adjoin an inner surface of the depressed portion 11a and transfer heat to the component, which is disposed in the seating portion C, through the depressed portion 11a.

The casing body 12 of the casing 10 may have an inlet port 10a and a discharge port 10b through which the coolant may be introduced and discharged as described above. The heat transfer module 100 may be disposed on the plate 11 comparatively closer to the discharge port 10b than the inlet port 10a. In this case, when a vehicle travels on a slope or a water pump for allowing the coolant to flow does not operate smoothly, a part of the coolant accommodated in the casing interior 13 is discharged through the discharge port 10b, such that a bubble trap G region may occur in the casing 10. In this case, in the bubble trap G region, the heating element is exposed to air, and a heat dissipation element is eliminated, which may cause a rapid increase in temperature. The heat transfer module 100 of the fluid heater according to the embodiment of the present invention may be coupled to the plate 11 by brazing, thereby ensuring durability and safety specifications. In addition, according to the fluid heater according to the embodiment of the present invention, the pair of connectors 21 and 22 and the plate 11 may be coupled by brazing, such that leak points may be minimized, thereby improving durability and performance. In addition, the heat transfer module 100 and the heating element 23 may also be coupled by brazing.

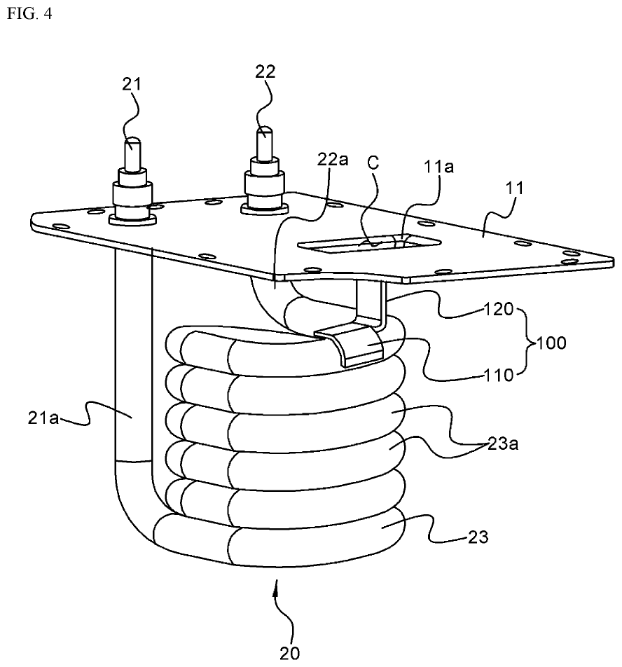

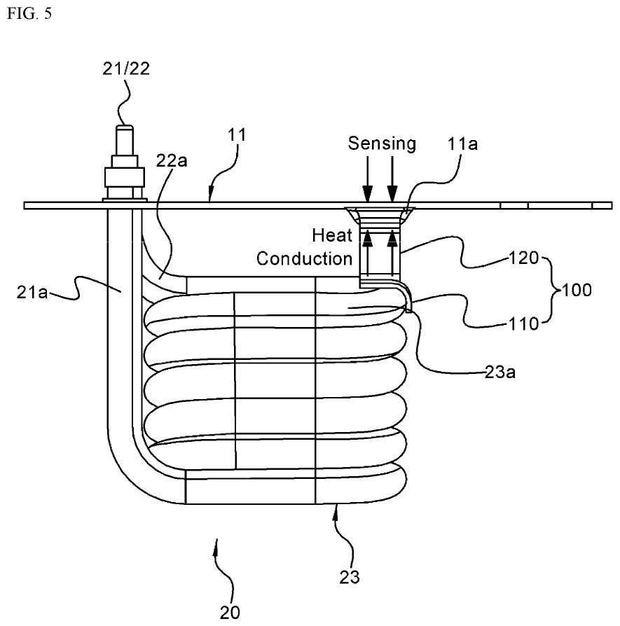

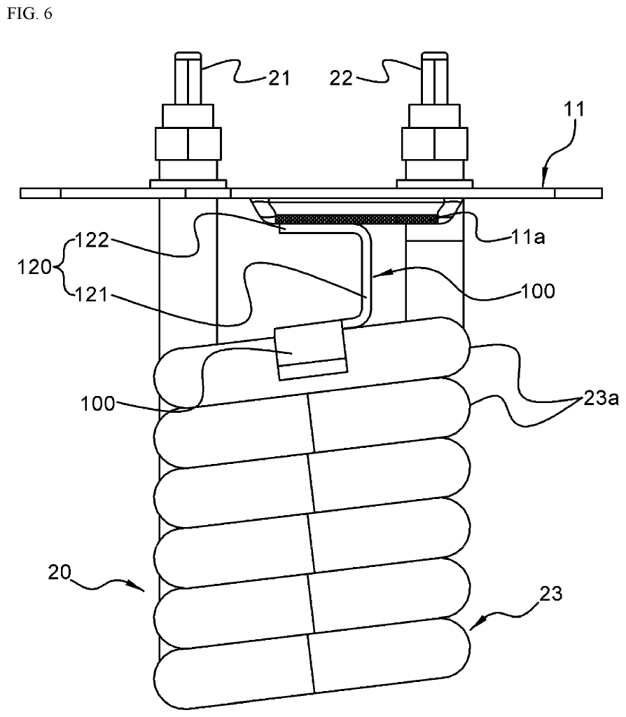

FIGS. 4 to 6 are views related to the fluid heater according to the embodiment of the present invention. FIG. 4 is a perspective view illustrating the fluid heater in a state in which the casing body is removed, FIG. 5 is a front view illustrating the fluid heater in a state in which the casing body is removed, and FIG. 6 is a side view illustrating the fluid heater in a state in which the casing body is removed.

With reference to FIG. 4, the heat transfer module 100 may include a first transfer member 110 being in contact with the heating element 23, and a second transfer member 120 configured to connect the first transfer member 110 to the plate 11 or the depressed portion 11a. In this case, one surface of the first transfer member 110 may be shaped to correspond to an outer surface of the heating element 23, such that one surface of the first transfer member 110 may be in surface contact with an outer peripheral surface of the heating element 23 while surrounding the outer peripheral surface of the heating element 23.

As illustrated, the heating element 23 is formed spirally, such that the heating element 23 may have a shape in which a plurality of unit heating elements 23a connected to one another is stacked. The pair of connectors 21 and 22 may further include extension portions 21a and 22a connected to the heating element 23. In this case, the first transfer member 110 may be disposed to adjoin the unit heating element 23a adjacent to the first transfer member 110 among the plurality of unit heating elements 23a.

With reference to FIG. 5, the first transfer member 110 is in contact with the adjacent unit heating element 23a, and the depressed portion 11a is formed in the plate 11, such that a length of the second transfer member 120 may be minimized, a route along which heat is transferred may be shortened, and accurate information may be measured within a short period of time. Further, the other surface of the first transfer member 110 may be in contact with the coolant flowing in the second transfer member 120 or the air heated by the bubble trap G, such that the heat may be transferred to the depressed portion 11a. Further, as described above, the temperature fuse, the temperature sensitive switch, the temperature sensor, or the like disposed in the depressed portion 11a detects the transferred heat. When a breakdown occurs, functions, such as a function of cutting off the supply of electric power or a function of raising an alarm to the outside, may be implemented in conjunction with the controller or the like. Further, the heat transfer module 100 measures a temperature of the coolant when the coolant is present. The heat transfer module 100 measures a temperature of the heating element 23 when the coolant is not present. During the process of testing the principle evaluation, the heat transfer module 100 may measure the overheating of the heating element 23, and the measurement result may be utilized in various shapes such as the evaluation of the assurance of the stability of the heater.

With reference to FIG. 6, the second transfer member 120 may include a connection member 121 having one end connected to the first transfer member 110, and a fixing member 122 connected to the other end of the connection member 121 and fixed to be in surface contact with an inner surface of the depressed portion 11a. Further, the first transfer member 110, the connection member 121, and the fixing member 122 may define a “U” shape or the like when viewed from the lateral side, which may minimize a decrease in flow of the coolant. Further, when the plurality of unit heating elements 23a is spirally connected and inclined at a predetermined angle with respect to the plate 11, the first transfer member 110 may also have an inclined shape.

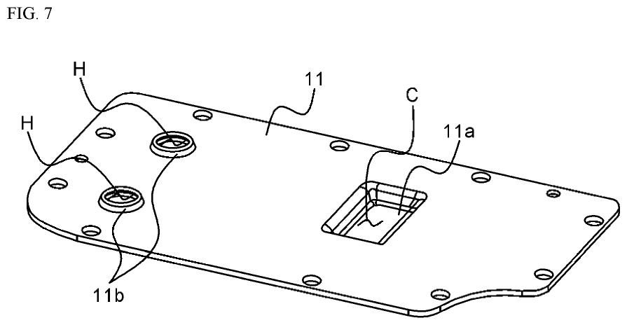

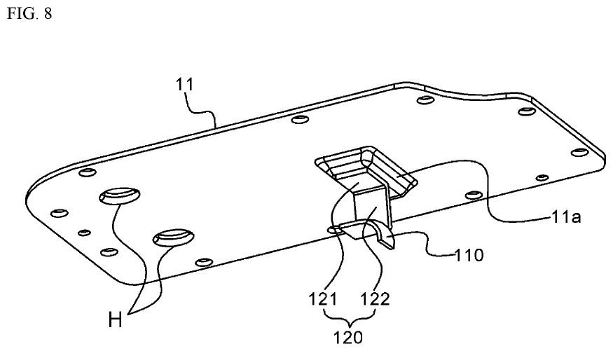

FIG. 7 and FIG. 8 is related to the fluid heater according to the embodiment of the present invention. FIG. 7 is a perspective view illustrating an outer surface of the plate, and FIG. 8 is a perspective view illustrating an inner surface of the plate.

With reference to FIG. 7 and FIG. 8, as described above, the depressed portion 11a is recessed inward in the outer surface of the plate 11, and thus the seating portion C is formed. Therefore, the seating portion C may guide the process of mounting the component for measuring the temperature, thereby improving assemblability. In addition, holes H may be formed in the plate 11, and the connectors may penetrate the holes H. A protruding portion 11b may be formed around each of the holes H and protrude outward or inward. The connector may be inserted into the protruding portion 11b and the hole H and then coupled by brazing, thereby further improving watertightness. Further, an inner surface of the depressed portion 11a of the plate 11 may have an embossed shape, which may shorten a thermal conduction distance. In this case, the embossed shape may be defined as various shapes such as a convexly embossed shape, a quadrangularly embossed shape, or a diamond embossed shape. The embossed shape may be designed to have a suitable depth in consideration of the occurrence of the decrease in flow of the coolant.

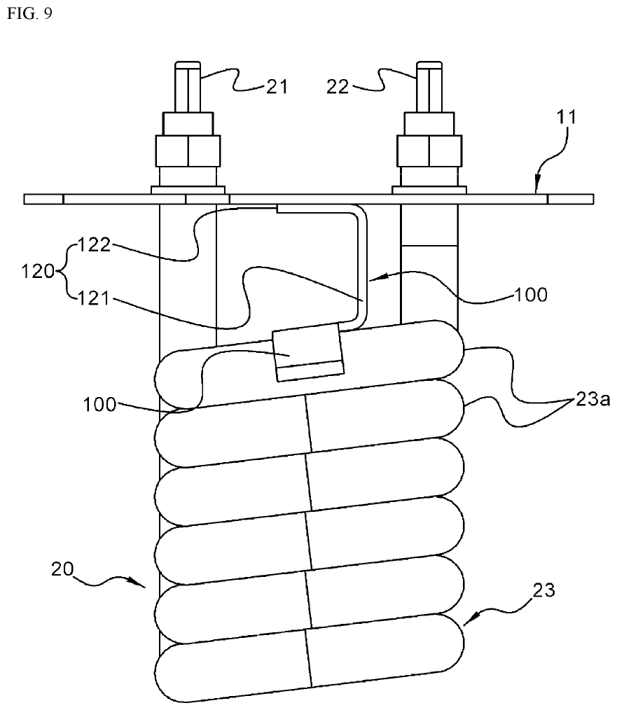

FIG. 9 is related to a fluid heater according to another embodiment of the present invention. FIG. 9 is a side view illustrating the fluid heater in a state in which a casing body is removed.

With reference to FIG. 9, the plate 11 of the fluid heater according to another embodiment of the present invention may have a flat plate shape. One end of the heat transfer module 100 may be in contact with the heating element 23, and the other end may be in surface contact with an inner surface of the plate 11. In this case, the heat transfer module 100 may include the first transfer member 110 connected to the heating element 23, and the second transfer member 120 configured to connect the first transfer member 110 and the inner surface of the plate 11. Further, an end of the second transfer member 120 may be configured to be in surface contact with the inner surface of the plate 11. In this case, the second transfer member 120 may include the connection member 121 having one end connected to the first transfer member 110, and the fixing member 122 connected to the other end of the connection member 121 and fixed to be in surface contact with the inner surface of the plate 11.

The present invention is not limited to the above embodiments, and the scope of application is diverse. Of course, various modifications and implementations made by any person skilled in the art to which the present invention pertains without departing from the subject matter of the present invention claimed in the claims.

### DESCRIPTION OF REFERENCE NUMERALS

C: Seating portion
F: Coolant
G: Bubble trap
H: Hole
10: Casing
10a: Inlet port
10b: Discharge port
11: Plate
11a: Depressed portion
11b: Protruding portion
12: Casing body
13: Casing interior
20: Heating module
21, 22: Connector
21a, 22a: Extension portion
23: Heating element
23a: Unit heating element
100: Heat transfer module
110: First transfer member
120: Second transfer member
121: Connection member
122: Fixing member

1. A fluid heater comprising:
a casing having therein a hollow portion in which a fluid flows;
a heating module including a connector disposed outside the casing and connected to a power source, and a heating element disposed in the casing and configured to be heated by electric power transmitted from the connector; and
a heat transfer module configured to transfer heat, which is generated by the heating element, to one surface of the casing,
wherein the heat transfer module is in contact with an inner surface of a plate having one end being in contact with the heating element, and the other end disposed on one surface of the casing.

2. The fluid heater of claim 1, wherein a part of the plate is recessed toward an interior of the casing to define a depressed portion, and the other end of the heat transfer module is in contact with an inner surface of the depressed portion.

3. The fluid heater of claim 2, wherein at least one of a temperature fuse, a temperature sensitive switch, and a temperature sensor is disposed on an outer surface of the depressed portion.

4. The fluid heater of claim 2, wherein the inner surface of the depressed portion has an embossed shape.

5. The fluid heater of claim 1, wherein the heat transfer module comprises:
a first transfer member being in contact with an outer surface of the heating element while surrounding the outer surface of the heating element; and
a second transfer member having one end connected to the first transfer member and the other end coupled to the inner surface of the plate.

6. The fluid heater of claim 2, wherein the heat transfer module comprises:
a first transfer member being in contact with an outer surface of the heating element while surrounding the outer surface of the heating element; and
a second transfer member having one end connected to the first transfer member and the other end coupled to the inner surface of the depressed portion, and
wherein the second transfer member comprises:
a connection member having one end connected to the first transfer member; and
a fixing member connected to the other end of the connection member and fixed to be in surface contact with the inner surface of the depressed portion.

7. The fluid heater of claim 5, wherein the heating element is formed spirally and includes a plurality of unit heating elements inclined at a predetermined angle, and the first transfer member is shaped to correspond to an outer peripheral surface of the adjacent unit heating element.

8. The fluid heater of claim 1, wherein the connector penetrates the plate, and the connector and the plate are coupled by brazing.

9. The fluid heater of claim 8, wherein the connector is provided as a plurality of connectors, and the two or more connectors are disposed to penetrate one plate.

10. The fluid heater of claim 8, wherein at least one connector including a positive electrode terminal is disposed to penetrate one plate.

11. The fluid heater of claim 8, wherein the plate has a hole into which the connector is inserted, and a protruding portion is formed around the hole of the plate and protrudes inward or outward from the casing.

12. The fluid heater of claim 1, wherein the other end of the heat transfer module and the inner surface of the plate are coupled to each other by brazing.

13. The fluid heater of claim 1, wherein the casing further comprises:
an inlet port 10a into which a coolant is introduced; and
a discharge port 10b through which the coolant is discharged, and
wherein the discharge port is disposed to be closer to the plate than the inlet port.
